(19) United States
(12) Patent Application Publication
(10) Pub. No.: US 2025/0259762 A1
(43) Pub. Date: Aug. 14, 2025

(54) RADIOISOTOPE PRODUCTION TARGET FOR PRODUCING RADIOISOTOPES USING PHOTONEUTRON PRODUCTION PROCESS

(71) Applicant: Westinghouse Electric Company LLC, Cranberry Township, PA (US)

(72) Inventors: Matthew S. Scott, Cranberry Township, PA (US); Michael D. Heibel, Broomfield, CO (US); Michael C. Prible, Cranberry Township, PA (US)

(73) Assignee: Westinghouse Electric Company LLC, Cranberry Township, PA (US)

(21) Appl. No.: 18/438,427

(22) Filed: Feb. 10, 2024

(51) Int. Cl. G21G 1/02; G21K 5/08

(52) U.S. Cl. CPC G21G 1/02; G21K 5/08

(57) ABSTRACT

An irradiation target for producing a radioisotope is provided. The irradiation target comprises an outer tube extending along a first axis and an inner tube extending along a second axis. The inner tube comprises an outer surface surrounded by the inner surface of the outer tube, and a primary irradiation target material. The inner surface of the outer tube and the outer surface of the inner tube define an intermediate cavity therebetween. The irradiation target further comprises a secondary irradiation target material positioned within the intermediate cavity. An irradiation target assembly and a method for producing a radioisotope is also provided.

### BACKGROUND

Radioisotopes of interest, such as pharmaceutically useful radioisotopes, can be synthetically produced via nuclear reactions in irradiation targets and/or assemblies thereof. The materials used in irradiation targets can include an irradiation material which may interact with an incident radiation, such as, for example, a neutron flux in a nuclear reactor, to produce a secondary emission and a precursor material which may interact with the secondary emission to result in a desired radioisotope. However, conventional irradiation targets can require multiple irradiation cycles as the irradiation material thereof is prone to being depleted prior to a conversion of all of the precursor material, thereby increasing radioactive material handling and/or time from initial radiation to end use of the desired radioisotope. Accordingly, current production of synthetic radioisotopes can suffer from issues associated with low production efficiency and/or increased safety hazards. Therefore, a need exists to develop alternative irradiation target assemblies and production methods therewith to optimize the efficiency and safety of radioisotope production.

### SUMMARY

The following summary is provided to facilitate an understanding of some of the innovative features unique to the aspects disclosed herein and is not intended to be a full description. A full appreciation of the various aspects disclosed herein can be gained by taking the entire specification, claims, and abstract as a whole.

In various aspects, an irradiation target for producing a radioisotope is disclosed. In some aspects, the irradiation target includes an outer tube extending along a first axis and an inner tube extending along a second axis. In some aspects, the outer tube includes a first end, a second end, and an inner surface between the first end and the second end. In some aspects, the inner tube defines an inner cavity therein and comprises an outer surface surrounded by the inner surface of the outer tube and a primary irradiation target material positioned within the inner cavity. In some aspects, the primary irradiation target material is configured to generate an emission based on exposure to a neutron flux. In some aspects, the inner surface of the outer tube and the outer surface of the inner tube define an intermediate cavity therebetween. In some aspects, the irradiation target includes a secondary irradiation target material positioned within the intermediate cavity. In some aspects, the secondary irradiation target material is configured to interact with the emission generated by the primary irradiation target material to produce the radioisotope.

In various aspects, an irradiation target assembly for producing a radioisotope is disclosed. In some aspects, the irradiation target assembly includes an outer tube extending along a central axis and comprising a first end and a second end, an inner tube extending along the central axis, a first end cap for the first end and a second end cap for the second end, and a target material. In some aspects, the inner tube defines an inner cavity therein, and an amount of Gadolinium-157 housed within the inner cavity. In some aspects, the inner tube is surrounded by the outer tube, wherein a volume enclosed between the inner surface of the outer tube and an outer surface of the inner tube defines an intermediate cavity. In some aspects, the first end cap and the second end cap are removably attached to the first end and the second end of the outer tube to maintain an axial and lateral positioning of the inner tube within the outer tube. In some aspects, the target material comprises Radium-226 and is positioned within the intermediate cavity.

In various aspects, method for producing a radioisotope is disclosed. In some aspects, the method includes exposing an irradiation target assembly to a neutron flux. In some aspects, the irradiation target assembly includes an outer tube extending along a central axis, and an inner tube extending along the central axis. In some aspects, the inner tube is surrounded by the outer tube. In some aspects, the inner tube includes a primary irradiation target material for generating an emission based on exposure to the neutron flux. In some aspects, a volume enclosed between an inner surface of the outer tube and an outer surface of the inner tube defines an intermediate cavity. In some aspects, the irradiation target assembly includes a secondary irradiation target material positioned within the intermediate cavity, wherein the secondary irradiation target material interacts with the emission generated by the primary irradiation target material to produce the radioisotope.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of any of the aspects disclosed herein.

### BRIEF DESCRIPTION OF THE DRAWINGS

The various aspects described herein, together with objects and advantages thereof, may best be understood by reference to the following description, taken in conjunction with the accompanying drawings as follows.

FIG. 1 is a partial cross section view of a nuclear reactor core, in accordance with at least one non-limiting aspect of the present disclosure.

FIG. 2 illustrates gamma flux produced by the irradiation target material as a function of irradiation time indicating a depletion of an irradiation target material, according to at least one non-limiting aspect of the present disclosure.

FIG. 3 illustrates a schematic representation of an irradiation target, according to at least one non-limiting aspect of the present disclosure.

FIG. 4 illustrates a cross-section view of the irradiation target of FIG. 3.

Corresponding reference characters indicate corresponding parts throughout the several views. The exemplifications set out herein illustrate various aspects of the present disclosure, in one form, and such exemplifications are not to be construed as limiting the scope of any of the aspects disclosed herein.

### DETAILED DESCRIPTION

Certain exemplary aspects of the present disclosure will now be described to provide an overall understanding of the principles of the composition, function, manufacture, and use of the compositions and methods disclosed herein. An example or examples of these aspects are illustrated in the accompanying drawing. Those of ordinary skill in the art will understand that the compositions, articles, and methods specifically described herein and illustrated in the accompanying drawing are non-limiting exemplary aspects and that the scope of the various examples of the present disclosure is defined solely by the claims. The features illustrated or described in connection with one exemplary aspect may be combined with the features of other aspects. Such modifications and variations are intended to be included within the scope of the present disclosure.

Reference throughout the specification to “various examples,” “some examples,” “one example,” “an example,” or the like, means that a particular feature, structure, or characteristic described in connection with the example is included in an example. Thus, appearances of the phrases “in various examples,” “in some examples,” “in one example,” “in an example,” or the like, in places throughout the specification are not necessarily all referring to the same example. Furthermore, the particular features, structures, or characteristics may be combined in any suitable manner in an example or examples. Thus, the particular features, structures, or characteristics illustrated or described in connection with one example may be combined, in whole or in part, with the features, structures, or characteristics of another example or other examples without limitation. Such modifications and variations are intended to be included within the scope of the present examples.

In the following description, like reference characters designate like or corresponding parts throughout the several views of the drawings. Also in the following description, it is to be understood that such terms as “forward,” “rearward,” “left,” “right,” “above,” “below,” “upwardly,” “downwardly,” and the like are words of convenience and are not to be construed as limiting terms.

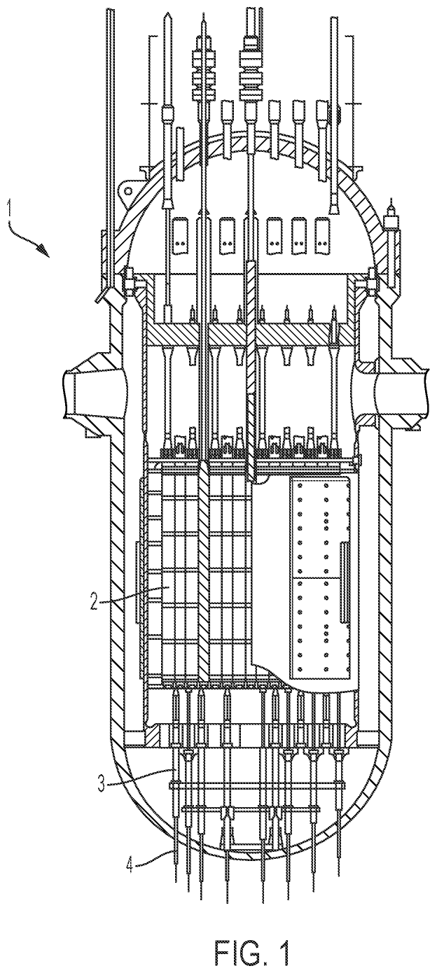

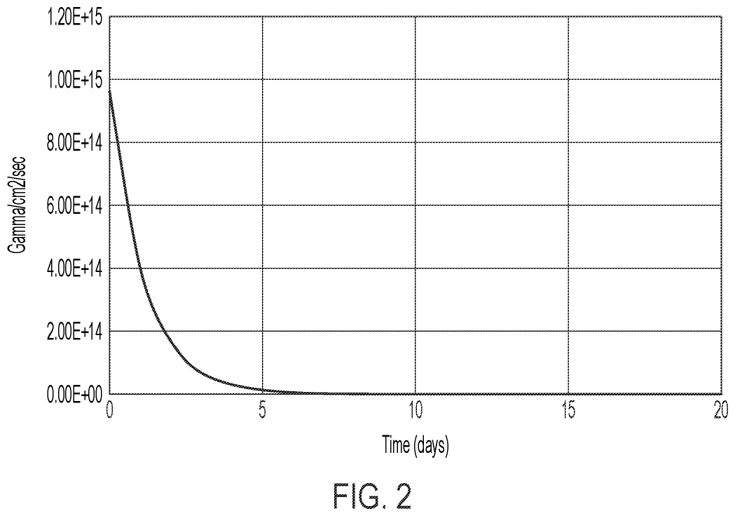

Generally, in a conventional nuclear reactor, such as a PWR, the reactor core can include a large number of fuel assemblies, each of which includes a plurality of elongated fuel elements or fuel rods. For example, FIG. 1 illustrates a cross-sectional elevation view of a reactor vessel 1, according to at least one non-limiting aspect of this disclosure. The reactor vessel 1 includes an organized array of elongated fuel rods 2 and a plurality of flux thimble tubes 3. The fuel rods 2 can house a plurality of fuel pellets each comprising a fissile material capable of sustaining a nuclear fission chain reaction, such as an enriched uranium-based material. The flux thimble tubes 3 are typically accessed through a number of narrow penetrations 4 connected to guide tubes of a separate target transfer system. Fission neutrons, such as prompt neutrons, are produced as a byproduct of these nuclear fission reactions and are slowed by interactions with neutron moderators present in the reactor core. Accordingly, the energy levels of the prompt fission neutrons are reduced to a thermal neutron energy. These thermal fission neutrons may also participate in nuclear reactions with an irradiation target material positioned within the reactor core, such as in a flux thimble tube, to produce one or more new nuclides and/or an emission of subatomic particles and/or energy. For example, a neutron capture reaction between a thermal neutron and Gadolinium-157 produces Gadolinium-158 accompanied by an emission of gamma radiation having an energy of greater than 6 megaelectronvolts (MeV). FIG. 2 shows a graph of gamma flux as a function of time illustrating the depletion of 100 milligrams (mg) of a 90% Gadolinium-157 enriched gadolinium oxide (Gd₂O₃). As illustrated in FIG. 2, a significant portion of Gadolinium-157 is depleted after about 5 days.

In the context of producing useful radioisotopes, a neutron flux comprising thermal neutrons, such as thermal fission neutrons, can be leveraged to irradiate a material which may directly produce or indirectly produce a desired radioisotope. For example, upon interacting with gamma radiation produced by a neutron capture reaction between a thermal neutron and Gadolinium-157, Radium-226 may enter an excited state, a subsequent decay thereof producing Actinium-225, a pharmaceutically useful radioisotope. In other words, Radium-226 is activated to produce a precursor to the desired Actinium-225 end product. Additional details are described in International Patent Application No. PCT/US2022/079372, entitled PRODUCING AC-225 USING GAMMA RADIATION, which was filed on Nov. 7, 2022, and which is hereby incorporated by reference herein in its entirety.

Irradiation targets may incorporate both Gadolinium-157 and Radium-226 based materials. However, the inventors of the present disclosure have determined that in conventional irradiation targets, the dosage of gamma radiation delivered to Radium-226 may be substantially less than the actual amount of gamma radiation produced by Gadolinium-157, thereby necessitating relatively large amounts of Gadolinium-157 for a given amount of Radium-226 and/or longer irradiation times which, due to Actinium-225's relatively short half-life of about 6.7 days, may increase the proportion of Actinium-225 which has begun to decay prior to removal of the irradiation target from the reactor core. Thus, producing radioisotopes such as Actinium-225 with conventional irradiation targets can suffer from issues associated with process inefficiency, increased production waste and/or decreased product efficacy, thereby increasing cost and/or limiting available supply of radionuclide-based treatments. The present disclosure provides irradiation targets and assemblies, and methods for producing radioisotopes which can mitigate the problems associated with currently available irradiation targets.

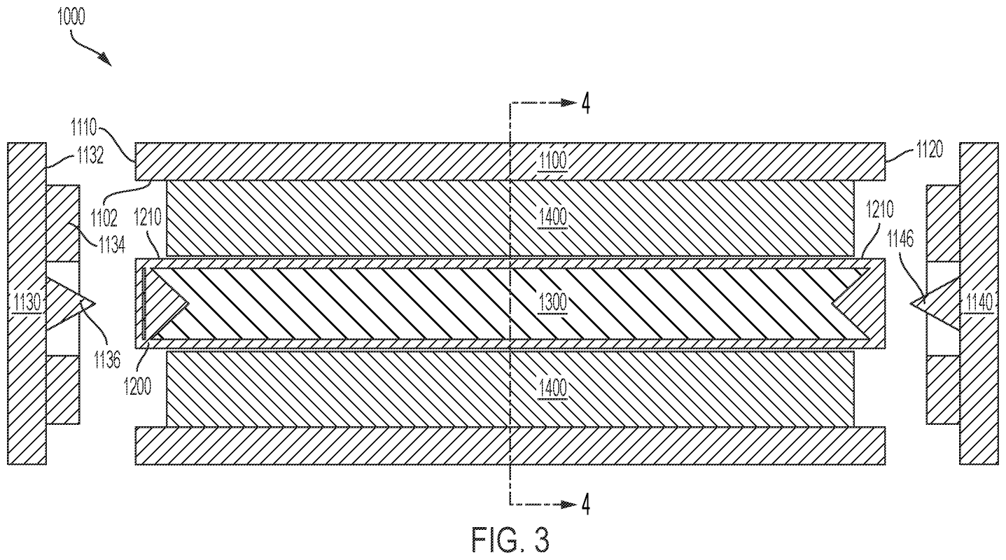

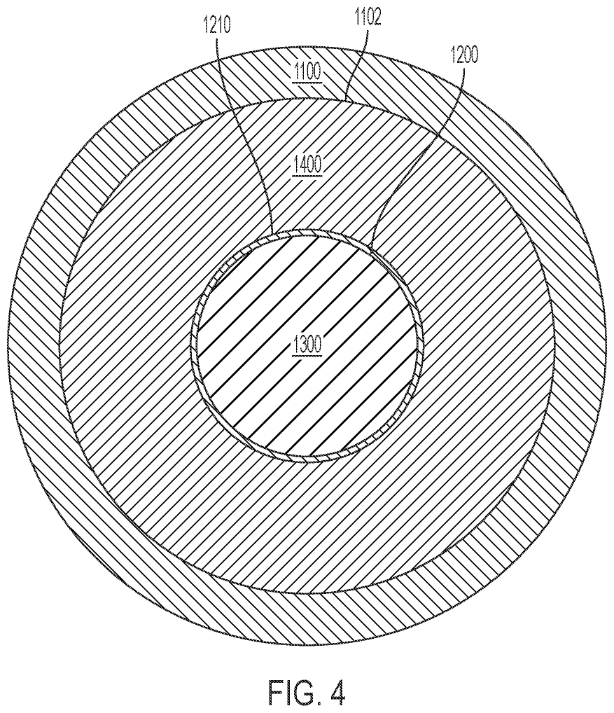

FIGS. 3 and 4 illustrate an irradiation target assembly 1000 for producing a radioisotope according to at least one non-limiting aspect of the present disclosure. FIG. 3 provides a schematic representation of the irradiation target assembly 1000 and FIG. 4 provides a cross-section view thereof. The irradiation target assembly 1000 includes an outer tube 1100 extending along a first axis, an inner tube 1200 extending along a second axis, a primary irradiation target material 1300 and a secondary irradiation target material 1400. In various examples, the outer tube 1100 is configured with a cylindrical geometry. In some examples, the dimensions of the irradiation target assembly 1000 are configured to fit within a flux thimble tube of a nuclear reactor. For example, an outer diameter of the outer tube 1100 can be substantially the same as, or slightly smaller than, an inner diameter of a flux thimble tube. In certain examples, the outer tube 1100 has an outer diameter of about 4.78 millimeters (“mm”).

Now referring to FIG. 3, the outer tube 1100 comprises a first end 1110 and a second end 1120, and an inner surface 1102 between the first end 1110 and the second end 1120. The first end 1110 and/or the second end 1120 can be closed to retain the inner tube 1200, the primary irradiation target material 1300, and the secondary irradiation target material 1400 during an exposure of the irradiation target assembly 1000 to a radiation, such as an incident thermal neutron flux in an operating reactor, during an irradiation cycle. In various examples, the first end 1110 is closed with a first end cap 1130 and the second end 1120 is closed with a second end cap 1140. Other configurations of the outer tube 1100 are contemplated by the present disclosure. For example, in some implementations, one end of the outer tube 1100 may be permanently closed while the other end is closed with a removable endcap.

The components of the irradiation target assembly 1000 which do not actively participate in a nuclear reaction during an irradiation cycle can be configured to minimize any radiation originating therefrom following the irradiation cycle. In various examples, the outer tube 1100 and the inner tube 1200 can be comprised of materials configured to minimize any radiation originating therefrom as a result of being exposed to a neutron flux during an irradiation cycle of the irradiation target assembly 1000. For example, the outer tube 1100 and the inner tube 1200 can independently be comprised of a material such as a zirconium-based alloy and/or a 316 series stainless steel. In examples where the irradiation target assembly 1000 includes a first end cap 1130 and/or a second end cap 1140, the end caps can be comprised of the same material as the outer tube 1100 and/or the inner tube 1200. In some aspects, this configuration of the irradiation target assembly 1000 can facilitate a handling, assembly, and/or disassembly thereof before and/or after an irradiation cycle. Thus, the irradiation target assembly 1000 can be configured to maintain safe operating conditions during a preparation and/or processing thereof.

The terms “lateral alignment” and “lateral offset” are used herein with reference to a position of a feature or structure relative to a specified axis in a plane normal to the specified axis. For example, in a hexagonal prism where the height/length extends between two hexagonal faces, the specified axis may extend through the centers the of the hexagonal faces and a laterally offset feature may be positioned on a hexagonal face at a distance away from the center of the face. Likewise, the terms “radial alignment” and “radial offset” are used herein with reference to a position of a feature or structure on or in a cylindrical body relative to the central longitudinal axis of the cylindrical body, in a reference plane normal to the central longitudinal axis.

Still referring to FIG. 3, in examples where the first end 1110 is closed with the first end cap 1130, the first end cap 1130 includes an inner face 1132 and a raised portion 1134 centered on the inner face 1132. The cross-section geometry of the raised portion 1134 is sized to be substantially the same as, or slightly smaller than, the cross-section geometry of the inner surface 1102 near the first end 1110. Thus, the first end cap 1130 is insertable into, or otherwise couplable with, the first end 1110 such that the radial center of the inner face 1132 is in alignment with the first axis of the outer tube 1100. In various examples, the first end cap 1130 and the inner surface 1102 near the first end 1110 may be configured to provide a reversible engagement therebetween, facilitating a removal thereof from the outer tube 1100. For example, the periphery of the raised portion 1134 and the inner surface 1102 near the first end 1110 can include threading to screw the first end cap 1130 into the outer tube 1100. In other examples, the periphery of the raised portion 1134 and the inner surface 1102 near the first end 1110 can include complementary grooves to provide a quick mechanical twist coupling. Thus, this configuration of the outer tube 1100 can facilitate assembly and/or disassembly of the irradiation target assembly 1000 components. Accordingly, in some aspects, the irradiation target assembly 1000 can be configured to facilitate a reuse and/or recycling of the components thereof in a subsequent irradiation cycle.

In examples where the first end 1110 is closed with a first end cap 1130, the first end cap 1130 engages the inner tube 1200 to form a first interface near the first end 1110. In various examples, the first end cap 1130 comprises a protrusion 1136 extending inwards from inner face 1132 for engaging an opening in an end of the inner tube 1200. The first interface can be configured to laterally align the second axis of the inner tube 1200 with respect to the first axis of the outer tube 1100. For example, since the radial center of the inner face 1132 is in alignment with the first axis of the outer tube 1100 upon coupling the first end cap 1130 with the first end 1110, a lateral positioning of the first interface, when engaging an end of the inner tube 1200, with respect to the first axis of the outer tube 1100, will be determined by the radial positioning of the protrusion 1136 with respect to the radial center of the inner face 1132 can be configured to provide. Thus, the location of the protrusion 1136 with respect to the radial center of the inner face 1132 can be configured to laterally align and/or offset the end of the inner tube 1200 participating in the first interface to the first axis of the outer tube 1100. In some examples, the protrusion 1136 is radially centered on the inner face 1132, thereby providing for a first interface which provides a coaxial alignment between the central axis and the second axis. In certain examples, the first end cap 1130 comprises a geometry that is complementary to the inner tube 1200. For example, the end of the inner tube 1200 to be engaged by the protrusion 1136 can have a circular opening and the protrusion 1136 can be configured with a conical geometry at least partially insertable into the circular opening. The base of the conically configured protrusion 1136 can have a diameter greater than, or substantially similar to, the diameter of the circular opening. Accordingly, in some aspects, the first end cap 1130 can be configured to facilitate a centering of the inner tube 1200 thereon based on a simple insertion of the protrusion 1136 into the inner tube 1200.

Further to the above, in examples where the second end 1120 is closed with a second end cap 1140, the second end cap 1140 can be configured similarly to the first end cap 1130. Thus, the second end cap 1140 can be configured as a removable end cap and can include a protrusion 1146 to engage the inner tube near the second end 1120 to form a second interface. When combined with the first interface, the second interface can limit axial motion of the inner tube 1200, while allowing axial motion of the inner tube 1200 upon disassembly of the irradiation target assembly 1000. Accordingly, the first interface and the second interface between the inner tube 1200 and the first and second end caps 1130 and 1140 can maintain an axial and lateral positioning of the inner tube 1200 within the outer tube 1100, while maintaining an ability to easily remove the inner tube 1200 upon disassembly of the irradiation target assembly 1000.

In various examples, the primary irradiation target material 1300 comprises an amount of a neutron capture material configured to generate an emission based on an exposure to a neutron flux, such as, for example, a thermal neutron flux within an operating nuclear reactor core, in a given irradiation cycle. In some examples, the primary irradiation target material 1300 is provided in a granular or powder form. The composition of the primary irradiation target material 1300 can be configured such that the emission to be generated comprises a photon emission, such as gamma radiation. For example, the primary irradiation target material 1300 can comprise Gadolinium-157 and/or an oxide thereof, which can emit gamma radiation having a high energy, such as greater than 6 MeV, upon interacting with an incident neutron flux on the order of about 10¹³ neutrons/centimeters²/second. Thus, in some aspects, the primary irradiation target material 1300 can produce an emission suitable for producing medical radioisotopes. In certain examples, the primary irradiation target material 1300 comprises Gd₂O₃.

The secondary irradiation target material 1400 is configured to interact with an emission generated by the primary irradiation target material 1300. In examples where the primary irradiation target material 1300 is configured to emit a flux of high energy photons, such as gamma radiation, the secondary irradiation target material 1400 can be configured to undergo a photonuclear reaction based on an interaction with the photon emission to provide a parent isotope to the desired isotope. The desired radioisotope will then be produced as a result of the subsequent decay of the parent. In various examples, the secondary irradiation target material 1400 is configured to produce an amount of a parent isotope to Actinium-225, such as Radium-225. For example, the secondary irradiation target material 1400 can comprise Radium-226, which can be transformed to Radium-225 upon receiving a dose of gamma radiation. A natural decay of Radium-225 thereafter produces an amount of Actinium-225 as a decay product thereof. In certain examples, the secondary irradiation target material 1400 comprises a salt of Radium-226, such as radium nitrate (Ra₂NO₃).

Referring back to FIGS. 3 and 4, the inner tube 1200 includes an outer surface 1210 having an outer diameter. When surrounded by the inner surface 1102 of the outer tube, the outer surface 1210 and the inner surface 1102 define an intermediate cavity therebetween. In various examples, the secondary irradiation target material 1400 can be positioned within this intermediate cavity. In some examples, the intermediate cavity is filled with the secondary irradiation target material 1400, such as, for example, after positioning the inner tube 1200 within the outer tube 1100. In certain examples, the secondary irradiation target material 1400 is to occupy an entire volume defined by the intermediate cavity. The form of the secondary irradiation target material 1400 can be configured to facilitate an addition and/or removal thereof. For example, the secondary irradiation target material 1400 can be provided in a powder or granular form which may be poured into and/or out from the intermediate cavity. The inventors of the present disclosure have determined that this arrangement of the secondary irradiation target material 1400 can forego requiring an expansion gap.

The inner tube 1200 is configured to contain the primary irradiation target material 1300, thereby positioning the primary irradiation target material 1300 radially inward of any secondary irradiation target material 1400. In various examples, the inner tube 1200 defines an inner cavity and an amount of the primary irradiation target material 1300, such as Gd₂O₃ in a powder form, is housed therein. In certain examples, the inner tube 1200 containing the primary irradiation target material 1300 is prefabricated to facilitate an insertion and/or replacement thereof. The inner tube 1200 is comprised of a material that is substantially transparent to thermal neutrons, such as, for example, a 316 series stainless steel, to allow an amount of primary irradiation target material 1300 positioned therein to interact with an incident thermal neutron flux. Thus, any emission to be produced by the primary irradiation target material 1300 is directed radially outward towards the secondary irradiation target material 1400, thereby increasing the likelihood of interaction therebetween. In some aspects, this configuration of the inner tube 1200 and the primary irradiation target material 1300 thereof can facilitate an optimization of an irradiation dose delivered to an amount of secondary irradiation target material 1400 within a given time window relative to the total emission produced by the primary irradiation target material 1300 over the given time window. Thus, the irradiation target assembly 1000 can be configured to minimize the amount of primary irradiation target material 1300 and/or irradiation cycle time required to produce an amount of a desired radioisotope from the secondary irradiation target material 1400. Accordingly, incorporating the irradiation target assembly 1000 into a pharmaceutical radioisotope production can avoid prematurely depleting the primary irradiation target material 1300 before the desired dose is delivered to the secondary irradiation target material 1400, thereby increasing production efficiency, decreasing material waste, and/or increasing efficacy of the pharmaceutical radioisotope.

Further to the above, the dosage delivered to the secondary irradiation target material 1400 can be tuned, such as, for example, by varying the ratio of the diameters of the inner tube 1200 and the outer tube 1100. In one example, the inner tube 1200 is configured with a cylindrical geometry with an outer surface 1210 having an outer diameter of about 1.5 mm and is centered within an inner surface 1102 having a diameter of about 4 mm, and a length of about 50 mm, and the outer tube 1100 includes an inner surface 1102 having a diameter of about 4 mm. The inventors of the present disclosure have determined that an irradiation target assembly 1000 incorporating this configuration can be employed to irradiate at least 10 mg of a Ra₂NO₃ based secondary irradiation target material 1400 before depletion of an amount of a primary irradiation target material 1300 corresponding to about 100 mg of Gadolinium-157, such as, for example, about 115 mg of Gd₂O₃.

As discussed herein, an irradiation target assembly for producing a radioisotope is provided by the present disclosure. The irradiation target assembly includes an outer tube comprising a first end and a second end, an inner tube defining an inner cavity therein which house an amount of inner neutron capture material comprising Gaolinium-157, a first end cap for the first end, and a second end cap for the second end. The inner tube is surrounded by the outer tube, both of which extend along a common central axis. Additionally, a volume is enclosed between an outer surface of the inner tube and an inner surface of the outer tube, thereby defining an intermediate cavity. An outer material, such as a target material comprising Radium-226, is positioned within the intermediate cavity. The first end cap is removably attached to the first end of the outer tube and the second end cap is removably attached to the second end of the outer tube. In various examples, the inner material comprising Gadolinium-157 is Gd₂O₃ and the target material comprising Radium-226 is Ra₂NO₃. Accordingly, the irradiation target assembly can be exposed to a neutron flux to produce an amount of Actinium-225 without requiring excess Gadolinium-157 to activate the outer material.

The outer tube, inner tube, first end cap and second end cap of the irradiation target assembly can be configured similarly to the outer tube 1100, inner tube 1200, and end caps 1130 and 1140, respectively, as described hereinabove. Thus, the first end cap and the second cap can be configured to maintain an axial and lateral positioning of the inner tube within the outer tube. In various examples, the outer tube and the inner tube of the irradiation target assembly have cylindrical geometries, thereby enclosing a ring shaped and/or annular volume which defines the intermediate cavity.

As discussed herein, a method for producing a radioisotope is provided by the present disclosure. In various examples, the method for producing a radioisotope includes exposing an irradiation target assembly to a neutron flux. The irradiation target assembly is similar in many respects to other irradiation targets and irradiation target assemblies disclosed elsewhere in the present disclosure, which are not repeated herein at the same level of detail for brevity. The irradiation target assembly to be exposed to the neutron flux includes an inner tube surrounded by an outer tube, both extending along a common central axis, wherein a volume enclosed between an inner surface of the outer tube and an outer surface of the inner tube defines an intermediate cavity. The inner tube defines an inner volume therein which houses an amount of a primary irradiation target material for generating an emission based on exposure to the neutron flux, and is surrounded by a secondary irradiation target material housed within the intermediate cavity which interacts with the emission generated by the neutron capture material to produce the radioisotope. In various examples, the primary irradiation target material comprises Gadolinium-157 and the secondary irradiation target material comprises Radium-226. Thus, the method according to the present disclosure can be configured to produce Actinium-225.

In various examples, the method according to the present disclosure can be configured to reuse and/or recycle components of the irradiation target assembly following an irradiation cycle. For example, the method can include removing an end cap from an end of the outer tube, removing the radioisotope produced from the target material, and reusing the outer tube, the inner tube, or the end cap, or any combination thereof, in a subsequent production of a radioisotope. In some examples, the method includes decontaminating a disassembled component prior to reuse in the subsequent production of a radioisotope.

Various aspects of the present disclosure include, but are not limited to, the aspects listed in the following numbered clauses.
Clause 1—An irradiation target for producing a radioisotope. The irradiation target comprises includes an outer tube extending along a first axis and an inner tube extending along a second axis. The outer tube comprises a first end, a second end, and an inner surface between the first end and the second end. The inner tube defines an inner cavity therein and comprises an outer surface surrounded by the inner surface of the outer tube and a primary irradiation target material positioned within the inner cavity. The primary irradiation target material is configured to generate an emission based on exposure to a neutron flux. The inner surface of the outer tube and the outer surface of the inner tube define an intermediate cavity therebetween. The irradiation target further comprises a secondary irradiation target material positioned within the intermediate cavity. The secondary irradiation target material is configured to interact with the emission generated by the primary irradiation target material to produce the radioisotope.
Clause 2—The irradiation target of clause 1, wherein the first end is closed with a first end cap and the second end is closed with a second end cap.
Clause 3—The irradiation target of clause 2, wherein the first end cap engages the inner tube to form a first interface near the first end, wherein the first interface laterally aligns the second axis with respect to the first axis.
Clause 4—The irradiation target of clause 3, wherein the first interface provides a coaxial alignment between the first axis and the second axis.
Clause 5—The irradiation target of any one of clauses 3 or 4, wherein the first end cap comprises a geometry that is complementary to the inner tube.
Clause 6—The irradiation target of clause 5, wherein the first end cap comprises a conical section at least partially insertable into the inner tube.
Clause 7—The irradiation target of any one of clauses 3-6, wherein the first end cap is removable.
Clause 8—The irradiation target of any one of clauses 3-7, wherein the second end cap engages the inner tube to form a second interface near the second end, wherein the first interface and the second interface maintain an axial and lateral positioning of the inner tube within the outer tube.
Clause 9—The irradiation target of any one of clauses 1-8, wherein the emission comprises a photon emission.
Clause 10—The irradiation target of clause 9, wherein the photon emission comprises gamma radiation.
Clause 11—The irradiation target of any one of clauses 1-10, wherein the primary irradiation target material comprises Gadolinium-157.
Clause 12—The irradiation target of any one of clauses 1-11, wherein the neutron flux comprises thermal fission neutrons.
Clause 13—The irradiation target of any one of clauses 1-12, wherein the radioisotope comprises Radium-225.
Clause 14—The irradiation target of any one of clauses 1-13, wherein the secondary irradiation target material comprises Radium-226.
Clause 15—The irradiation target of any one of clauses 1-14, wherein the intermediate cavity is filled with the secondary irradiation target material.
Clause 16—The irradiation target of clause 15, wherein the secondary irradiation target material is to occupy an entire volume defined by the intermediate cavity.
Clause 17—The irradiation target of any one of clauses 1-16, wherein the dimensions of the irradiation target are configured to fit within a flux thimble tube of a nuclear reactor.
Clause 18—An irradiation target assembly for producing a radioisotope. The irradiation target assembly comprises an outer tube extending along a central axis, an inner tube extending along the central axis, a first end cap, a second end cap, and a target material. The outer tube comprises a first end and a second end. The first end cap is for the first end and the second end cap is for the second end. The inner tube defines an inner cavity therein, and an amount of Gadolinium-157 housed within the inner cavity. The inner tube is surrounded by the outer tube, wherein a volume enclosed between the inner surface of the outer tube and an outer surface of the inner tube defines an intermediate cavity. The first end cap and the second end cap are removably attached to the first end and the second end of the outer tube to maintain an axial and lateral positioning of the inner tube within the outer tube. The target material comprises Radium-226 and is positioned within the intermediate cavity.
Clause 19—A method for producing a radioisotope. The method comprises exposing an irradiation target assembly to a neutron flux. The irradiation target assembly comprises an outer tube extending along a central axis, and an inner tube extending along the central axis. The inner tube is surrounded by the outer tube. The inner tube comprises a primary irradiation target material for generating an emission based on exposure to the neutron flux. A volume enclosed between an inner surface of the outer tube and an outer surface of the inner tube defines an intermediate cavity. The irradiation target assembly further comprises a secondary irradiation target material positioned within the intermediate cavity, wherein the secondary irradiation target material interacts with the emission generated by the primary irradiation target material to produce the radioisotope.
Clause 20—The method of clause 19, wherein the method further comprises removing an end cap from an end of the outer tube; removing the radioisotope produced from the target material; and reusing the outer tube, the inner tube, or the end cap, or any combination thereof, in a subsequent production of a radioisotope.

Various features and characteristics are described in this specification to provide an understanding of the composition, structure, production, function, and/or operation of the disclosure, which includes the disclosed methods and systems. It is understood that the various features and characteristics of the disclosure described in this specification can be combined in any suitable manner, regardless of whether such features and characteristics are expressly described in combination in this specification. The Inventors and the Applicant expressly intend such combinations of features and characteristics to be included within the scope of the disclosure described in this specification. As such, the claims can be amended to recite, in any combination, any features and characteristics expressly or inherently described in, or otherwise expressly or inherently supported by, this specification. Furthermore, the Applicant reserves the right to amend the claims to affirmatively disclaim features and characteristics that may be present in the prior art, even if those features and characteristics are not expressly described in this specification. Therefore, any such amendments will not add new matter to the specification or claims and will comply with the written description, sufficiency of description, and added matter requirements.

With respect to the appended claims, those skilled in the art will appreciate that recited operations therein may generally be performed in any order. Also, although various operational flows are presented in a sequence(s), it should be understood that the various operations may be performed in other orders than those that are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

The invention(s) described in this specification can comprise, consist of, or consist essentially of the various features and characteristics described in this specification. The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. Thus, a method or system that “comprises,” “has,” “includes,” or “contains” a feature or features and/or characteristics possesses the feature or those features and/or characteristics but is not limited to possessing only the feature or those features and/or characteristics. Likewise, an element of a composition, coating, or process that “comprises,” “has,” “includes,” or “contains” the feature or features and/or characteristics possesses the feature or those features and/or characteristics but is not limited to possessing only the feature or those features and/or characteristics and may possess additional features and/or characteristics.

The grammatical articles “a,” “an,” and “the,” as used in this specification, including the claims, are intended to include “at least one” or “one or more” unless otherwise indicated. Thus, the articles are used in this specification to refer to one or more than one (i.e., to “at least one”) of the grammatical objects of the article. By way of example, “a component” means one or more components and, thus, possibly more than one component is contemplated and can be employed or used in an implementation of the described compositions, coatings, and processes. Nevertheless, it is understood that use of the terms “at least one” or “one or more” in some instances, but not others, will not result in any interpretation where failure to use the terms limits objects of the grammatical articles “a,” “an,” and “the” to just one. Further, the use of a singular noun includes the plural, and the use of a plural noun includes the singular, unless the context of the usage requires otherwise.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Also, all ranges recited herein are inclusive of the end points of the recited ranges. For example, a range of “1 to 10” includes the end points 1 and 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

As used in this specification, particularly in connection with layers, the terms “on,” “onto,” “over,” and variants thereof (e.g., “applied over,” “formed over,” “deposited over,” “provided over,” “located over,” and the like) mean applied, formed, deposited, provided, or otherwise located over a surface of a substrate but not necessarily in contact with the surface of the substrate. For example, a layer “applied over” a substrate does not preclude the presence of another layer or other layers of the same or different composition located between the applied layer and the substrate. Likewise, a second layer “applied over” a first layer does not preclude the presence of another layer or other layers of the same or different composition located between the applied second layer and the applied first layer.

Whereas particular examples of this disclosure have been described above for purposes of illustration, it will be evident to those skilled in the art that numerous variations of the details of the present disclosure may be made without departing from the disclosure as defined in the appended claims.

What is claimed is:

1. An irradiation target for producing a radioisotope, the irradiation target comprising:
an outer tube extending along a first axis, the outer tube comprising:
a first end;
a second end; and
an inner surface between the first end and the second end;
an inner tube extending along a second axis, the inner tube defining an inner cavity therein, wherein the inner tube comprises:
an outer surface surrounded by the inner surface of the outer tube, wherein the inner surface of the outer tube and the outer surface of the inner tube define an intermediate cavity therebetween; and
a primary irradiation target material positioned within the inner cavity, wherein the primary irradiation target material is configured to generate an emission based on exposure to a neutron flux; and
a secondary irradiation target material positioned within the intermediate cavity, wherein the secondary irradiation target material is configured to interact with the emission generated by the primary irradiation target material to produce the radioisotope.

2. The irradiation target of claim 1, wherein the first end is closed with a first end cap and the second end is closed with a second end cap.

3. The irradiation target of claim 2, wherein the first end cap engages the inner tube to form a first interface near the first end, wherein the first interface laterally aligns the second axis with respect to the first axis.

4. The irradiation target of claim 3, wherein the first interface provides a coaxial alignment between the first axis and the second axis.

5. The irradiation target of claim 3, wherein the first end cap comprises a geometry that is complementary to the inner tube.

6. The irradiation target of claim 5, wherein the first end cap comprises a conical section at least partially insertable into the inner tube.

7. The irradiation target of claim 3, wherein the first end cap is removable.

8. The irradiation target of claim 3, wherein the second end cap engages the inner tube to form a second interface near the second end, wherein the first interface and the second interface maintain an axial and lateral positioning of the inner tube within the outer tube.

9. The irradiation target of claim 1, wherein the emission comprises a photon emission.

10. The irradiation target of claim 9, wherein the photon emission comprises gamma radiation.

11. The irradiation target of claim 1, wherein the primary irradiation target material comprises Gadolinium-157.

12. The irradiation target of claim 1, wherein the neutron flux comprises thermal fission neutrons.

13. The irradiation target of claim 1, wherein the radioisotope comprises Radium-225.

14. The irradiation target of claim 13, wherein the secondary irradiation target material comprises Radium-226.

15. The irradiation target of claim 1, wherein the intermediate cavity is filled with the secondary irradiation target material.

16. The irradiation target of claim 15, wherein the secondary irradiation target material is to occupy an entire volume defined by the intermediate cavity.

17. The irradiation target of claim 1, wherein the dimensions of the irradiation target are configured to fit within a flux thimble tube of a nuclear reactor.

18. An irradiation target assembly for producing a radioisotope, the irradiation target assembly comprising:
an outer tube extending along a central axis, the outer tube comprising a first end and a second end;
an inner tube extending along the central axis, the inner tube defining an inner cavity therein, and an amount of Gadolinium-157 housed within the inner cavity, wherein the inner tube is surrounded by the outer tube, wherein a volume enclosed between an inner surface of the outer tube and an outer surface of the inner tube defines an intermediate cavity;
a first end cap for the first end and a second end cap for the second end, wherein the first end cap and the second end cap are removably attached to the first end and the second end of the outer tube to maintain an axial and lateral positioning of the inner tube within the outer tube; and
a target material positioned within the intermediate cavity, wherein the target material comprises Radium-226.

19. A method for producing a radioisotope, the method comprising:
exposing an irradiation target assembly to a neutron flux, the irradiation target assembly comprising:
an outer tube extending along a central axis;
an inner tube extending along the central axis, the inner tube comprising a primary irradiation target material for generating an emission based on exposure to the neutron flux, wherein the inner tube is surrounded by the outer tube, wherein a volume enclosed between an inner surface of the outer tube and an outer surface of the inner tube defines an intermediate cavity; and
a secondary irradiation target material positioned within the intermediate cavity, wherein the secondary irradiation target material interacts with the emission generated by the primary irradiation target material to produce the radioisotope.

20. The method of claim 19, wherein the method further comprises:
removing an end cap from an end of the outer tube;
removing the radioisotope produced from the secondary irradiation target material; and
reusing the outer tube, the inner tube, or the end cap, or any combination thereof, in a subsequent production of a radioisotope.
